(19) United States
(12) Patent Application Publication
(10) Pub. No.: US 2026/0200070 A1
(43) Pub. Date: Jul. 16, 2026

(54) WHEEL-FOOT MOBILE MANIPULATOR ROBOT

(71) Applicant: Simon Kalouche, San Francisco, CA (US)

(72) Inventor: Simon Kalouche, San Francisco, CA (US)

(21) Appl. No.: 19/447,718

(22) Filed: Jan. 13, 2026

Related U.S. Application Data
(60) Provisional application No. 63/744,751, filed on Jan. 13, 2025.

(51) Int. Cl. B25J 5/00; B25J 9/14; B25J 9/16

(52) U.S. Cl. CPC B25J 5/00; B25J 9/14; B25J 9/1697

(57) ABSTRACT

A mobile manipulator robot designed to transition between different modes of mobility. The robot includes a torso, a plurality of legs, at least one manipulator arm including a first end coupled to the torso and a working end, and an end effector removably securable to the working end of the manipulator arm. The plurality of legs including a first wheel and a foot. Each of the feet being moveable relative the wheel located on a respective leg between a first position, in which the foot is in contact with the ground, and a second position in which the foot is elevated above the ground. The first end of the manipulator arm is moveable in an upward and downward direction relative the torso and allows the robot to efficiently position the end effector at various elevations relative to the ground to manipulate items.

### CROSS-REFERENCE TO RELATED APPLICATIONS

This application claims the benefit of the filing date of United States Provisional Patent Application No. 63/744,751 filed January 13, 2025, the disclosure of which is hereby incorporated herein by reference.

### BACKGROUND OF THE DISCLOSURE

The present disclosure generally relates to a mobile manipulator robot, and more particularly, to a manipulator robot having a mobility assembly designed to combine the efficiency of wheels with the versatility and adaptability of feet.

Robots have long been used to automate repetitive tasks that would otherwise be performed by a worker, thereby freeing workers to perform non-repetitive or higher-level tasks. As a result, robots have become indispensable in meeting rising production demands, combating labor shortages, and improving operational consistency.

Recent advances in artificial intelligence (AI), machine learning, and sensor technology have enhanced robotic intelligence, and enabled robots to learn from their environments and operate autonomously as they complete more complex tasks. Accordingly, robots have been increasingly deployed in various industries including, but not limited to, manufacturing, healthcare, agriculture, logistics, and hospitality services.

Robots conventionally fall into one of two categories: wheeled robots or legged robots. Wheeled robots are commonly preferred when navigating smooth, flat surfaces as their wheels provide speed and efficiency. Thus, wheeled robots are widely used to perform transport, delivery, and inspection tasks in environments such as factories, warehouses, hospitals, and other settings having unobstructed and flat terrain. However, their capabilities are limited when it comes to navigating rough terrain, climbing curbs or stairs, or operating in non-static environments where the robot is likely to encounter obstacles. In complex environments, such as construction sites, outdoor terrains, or even dynamic indoor spaces with obstacles, wheeled robots can encounter significant mobility challenges that inhibit their effectiveness.

Legged robots, which can be inspired by animal movement, offer superior adaptability in uneven terrains, as they can step over obstacles, navigate stairs, and maintain balance in dynamic environments. However, legged robots are generally slower, less energy-efficient, and more mechanically complex than wheeled robots. Accordingly, legged robots often are more expensive to manufacture and maintain, which has limited their widespread adoption, particularly in scenarios that do not demand such complex capabilities.

### BRIEF SUMMARY OF THE DISCLOSURE

The wheel-foot robot disclosed herein addresses the limitations of traditional wheeled and legged robots by combining the speed and energy efficiency of wheels with the stability and adaptability of feet. This hybrid system allows the robot to transition seamlessly between different modes of mobility, ensuring efficient movement across a variety of terrain types and the ability to interact with obstacles or uneven surfaces with ease.

Furthermore, the wheel-foot manipulator robot disclosed herein includes one or more manipulator arms having a first end coupled to a torso of the robot and a working end. The first end of the manipulator robot may be vertically movable relative to the torso (e.g., toward or away from a hip located at the proximal end of the legs of the robot). Furthermore, the wheel-foot manipulator robot disclosed herein includes one or more manipulator arms having a first end coupled to a torso of the robot and a working end. The first end of the manipulator robot may be vertically movable relative to the torso (e.g., toward or away from a hip located at the proximal end of the legs of the robot). In this regard, the first end of the picking arm(s) can be moved downward, toward the legs of the robot, to grasp or otherwise manipulate an otherwise hard to reach item located adjacent to the ground, for example, when the item is located underneath a seat or on a lower shelf. On the other hand, the first end of the manipulator arm(s) can be moved upward, away from the legs of the robot, when the robot is tasked with grasping or otherwise manipulating an item elevated above a ground surface.

In accordance, with a first aspect of the present disclosure, a wheel-foot manipulator robot is provided. The robot includes: a torso; a plurality of legs having at least two degrees of freedom relative to the torso, each of the plurality of legs including a foot and a drive wheel, the foot being moveable relative to the leg between a first position, in which the foot is in contact with the ground and the drive wheel is elevated above the ground, and a second position in which the foot is elevated above the ground and the drive wheel is contact with the ground; a manipulator arm having a first end coupled to the torso and a working end, the first end of the manipulator arm being moveable in an upward and downward direction relative to the torso; and an end effector removably securable to the working end of the manipulator arm.

The robot may further include a stabilizing wheel located on a lower end of the torso, whereby the torso may be moveable relative to the plurality of legs between a stabilized position in which the stabilizing wheel is in contact with the ground and an elevated position in the stabilizing wheel is elevated above the ground.

The robot may further include a stabilizing wheel located on each of the plurality of legs, whereby each of the plurality of legs may be moveable between a stabilized position in which the stabilizing wheel is in contact with the ground and a non-stabilized position in the stabilizing wheel is elevated above the ground.

The torso may further include an upper section and a lower section, and wherein the upper section and the lower section may be slidable or pivotable relative to one another.

In some aspects, the end effector may be pneumatically actuated. The robot may further include an air tank for operating the end effector, and a pneumatic coupler configured to access compressed air from an external pneumatic source to refill the air tank.

The robot may further include an end effector holder arranged to secure the end effector and/or another end effector, and the another end effector, whereby the end effector holder and the another end effector may be interchangeably coupleable to the working end of the manipulator arm.

The foot located on a respective one of the plurality of legs may be vertically displaceable relative the wheel located on the respective one of the plurality of legs between the first position and the second position.

The foot located on a respective one of the plurality of legs may be pivotable about the respective one of the plurality of legs between the first position and the second position.

The torso may define a cavity for storing and transporting items. Additionally, or alternatively, the torso may include a hook or a tray. In some examples, the hook or the tray may be pivotable between an extended position and retracted position.

The robot may further include a head coupled to the torso, the head including a camera.

The robot may further include a vision system movable in an upward and downward direction relative to the torso.

The manipulator arm may be coupled to the torso via the vision system such that the manipulator arm and vision system are jointly moveable relative to the torso.

Each of the plurality of legs may include a thigh pivotably connected to a shin at a joint.

The robot may further include a stability wheel located at the joint of each one of the plurality of legs.

In another embodiment, the robot includes: a torso; a plurality of legs coupled to the torso and having at least two degrees of freedom, each of the plurality of legs including a drive wheel and a kick stand, the kick stand being deployable relative to a respective leg between a first position, in which the kick stand is in contact with the ground when the wheel on the respective leg is stabilized against the ground, and a second position in which the kick stand is elevated above the ground when the wheel on the respective leg is stabilized against the ground; a manipulator arm having a first end coupled to the torso and a working end, the first end of the manipulator arm being moveable in an upward and downward direction relative the torso; and an end effector removably securable to the working end of the manipulator arm.

### BRIEF DESCRIPTION OF THE DRAWINGS

FIG. 1 is a perspective view of a mobile manipulator robot in accordance with an embodiment of the present disclosure.

FIG. 2 is a perspective view of a rack and pinion connection used to couple the torso to legs of mobile manipulator robot of FIG. 1.

FIG. 3 is an elevation view of a leg of the manipulator robot of FIG. 1.

FIG. 4 is a side elevation view of the mobile manipulator robot of FIG. 1 including a torso having an upper section and a lower section.

FIG. 5A is an elevation view of a mobility assembly of the manipulator robot of FIG. 1 illustrating a foot in an undeployed position.

FIG. 5B is an elevation view of a mobility assembly of the manipulator robot of FIG. 1 illustrating a foot in a deployed position.

FIG. 5C is an elevation view of a planetary gear.

FIG. 6 is a perspective view of a mobile manipulator robot including a leg defining a knee provided with a stability wheel in accordance with an embodiment of the present disclosure.

FIG. 7A is an elevation view of the leg of the robot of FIG. 6 depicting the stability wheel in a lifted position.

FIG. 7B is an elevation view of the leg of the robot of FIG. 6 depicting the stability wheel in a deployed or stabilized position.

### DETAILED DESCRIPTION

The technology disclosed herein relates to a robot having a wheel-foot mobility assembly that combines the speed and energy efficiency of wheels with the stability and adaptability of feet. This hybrid mobility assembly allows the robot to quickly transition between mobility modes to seamlessly traverse a variety of terrains.

As used herein, when terms of orientation, for example, "vertical" and "horizontal" or relative terms such as, "above," "upwards," "beneath," "downwards" and the like are used to describe the orientation, relative position, or relative movement of specific features of the robot, the terms are in reference to the orientation or the relative position of the features in the normal gravitational frame of reference when the robot is resting on the ground. Also as used herein, the terms "substantially," "generally," and "about" are intended to mean that slight deviations from absolute are included within the scope of the term so modified.

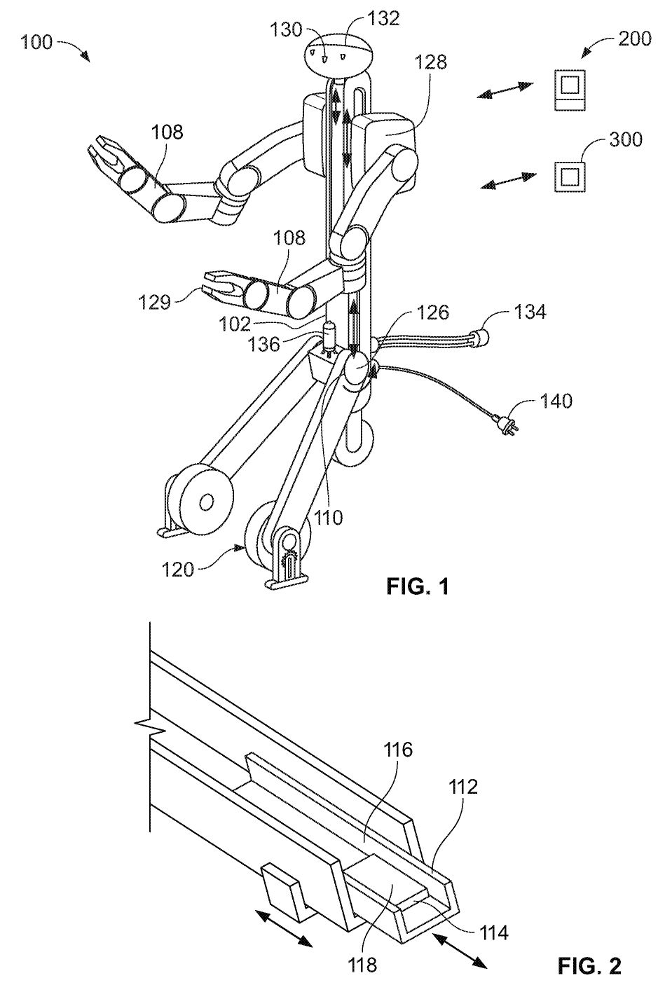

FIGS. 1 and 4 illustrate a robot 100 including a hybrid mobility assembly in accordance with an embodiment of the present disclosure. Robot 100 may include a torso 102, a head 104, a plurality of legs 106, and at least one manipulator arm 108. Each leg 106 may include a first end coupled to torso 102 at a hip 110 and the leg may have at least two degrees of freedom (e.g., hip abduction/adduction, hip pitch, knee pitch; hip abduction/adduction, hip vertical/prismatic motion relative to torso and hip pitch rotation). In some instances, torso 102 is designed to move in an upward and downward direction and relative to hip 110. Inversely, hip 110 can move upwards or downwards relative to the torso 102. For example, as shown in FIG. 2, a rail 112 defining a channel 114 may be disposed within torso 102 such that the channel faces outwardly away from each lateral side of the torso. Rail 112, as shown in FIG. 2, may define a u-shaped channel. A rack 116 may be disposed within the u-shaped channel 114 and a pinion 118 provided at hip 110 may be engaged with the rack. The pinion 118 is operatively coupled to a motor (not shown) that is designed to rotate the pinion to move the pinion in an upward direction and a downward direction along rack 116. In this regard, as the motor rotates the pinion, torso 102 may be raised or lowered relative to the ground.

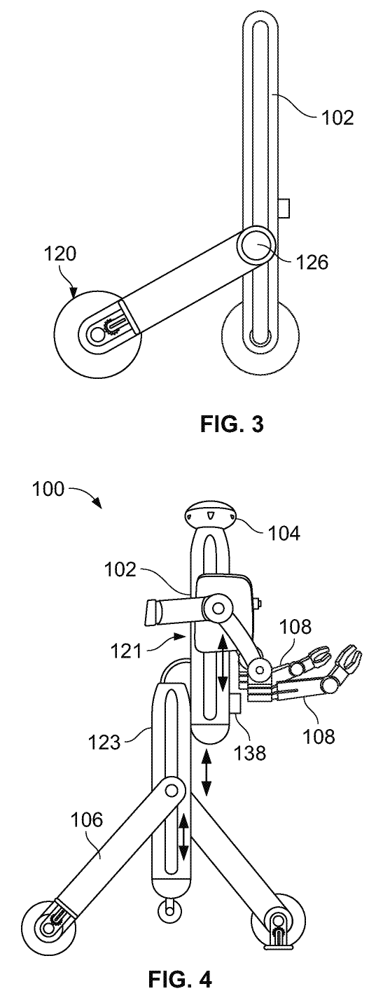

As shown in FIG. 3, when torso 102 is lowered, relative to hip 110, a bottom of torso 102 is lowered towards the ground. Conversely, as torso 102 is raised relative to the hip 110, the bottom of the torso is lifted away from the ground. It will be appreciated that any other mechanisms other than racks and pinions may be utilized to move torso 102 relative to hip 110, for example, chains, belts, cables, friction drives, linkages, etc. may be used to perform the same function. Moreover, as used herein, when two features are described as being coupled in a manner that allows one feature to move in an upward and downward direction relative to another feature, the term may, but need not mean, a substantially “vertical direction” (e.g., along a longitudinal axis).

Torso 102, as shown in FIG. 4 may include an upper section 121 and a lower section 123 configured to move in an upward and downward direction relative to one another. For example, upper section 121 and lower section 123 may telescope, rotate about a pivot axis, or other otherwise move relative to one another. The multi-component and compact torso design, illustrated in FIG. 4, further reduces the total size of robot 100, and also, improves stability by providing the robot with a lower center of gravity while performing tasks closer to the ground without sacrificing the robot ability to perform tasks when in an elongated state. In this regard, robot 100 can perform transport tasks or otherwise operate in confined spaces, for example, environments with low ceilings and the like.

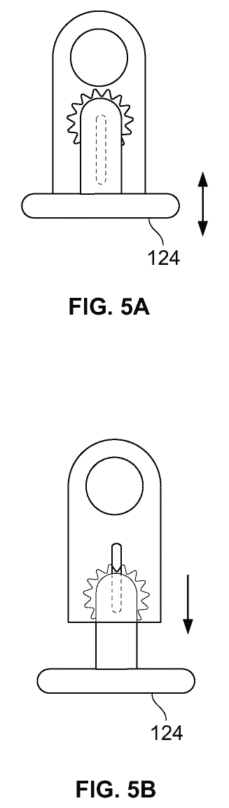

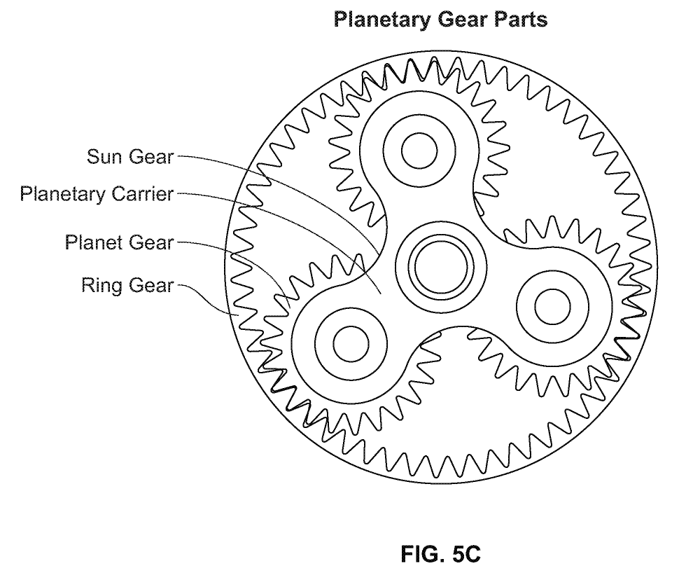

Turning now to FIGS. 5A and 5B, each leg 106 may include a mobility assembly 120 having a drive wheel 122 and a foot 124. While FIGS. 1 and 4 illustrate robot 100 with two legs 106, it will be appreciated that the robot may include any number of legs greater than two, for example, four legs. Each of drive wheels 122 may include a direct drive (not shown) or a hub motor (not shown) to rotate drive wheels 122 and guide robot 100 along the ground. Alternatively, drive wheels 122 may be controlled by a motor 126 located at, or adjacent to, the hip 110 of robot 100. Motor 126 may in turn be operatively coupled to the drive wheel 122 via a belt or chain, which advantageously situates the mass of the actuators closer to the hip 110 for lower leg inertia and improved dynamics and system controllability.

Feet 124 may be transitioned between a first position, in which the foot is in contact with the ground (FIG. 5B) and the drive wheel is elevated above ground, and a second position in which the foot is elevated above the ground and the drive wheel is in contact with the ground (FIG. 5A). For example, in some instances, feet 124 may be vertically translatable relative to drive wheel 122. In other instances, feet 124 may be pivotable about an axis of the leg 106.

It will be appreciated that the feet 124 may be actuated between the first and second positions in a multitude of manners. For example, in some instances, feet 124 may be moved between the first and second position via a dedicated actuator located on or within a respective leg 106. In other instances, a prescribed motion of the leg 106 of robot 100 may cause a respective foot 124 to be moved between the first and second positions. By way of example, legs 106 may have spring-loaded mechanism with a cam that allows the feet to be actuated between the first position (e.g., a deployed condition) and a second position (e.g., an undeployed condition). Feet 124 may be actuated between the first and second position when robot 100 engages the spring-loaded mechanism against an object in the environment or a feature of the robot, such as another leg 106 or torso 102, to trigger the foot to be deployed for extra stability. Still yet, the feet 124 may be manually transitioned between the first and second positions using the at least one manipulator arm 108 through a linkage, directly or via other means. A combination of any of the above may also be employed.

Feet 124 may be constructed in a multitude of ways so long as the feet have several degrees of freedom to facilitate stability and versatility. For example, feet 124 may have a pitch, yaw, and/or roll degree of freedom. In one non-limiting example, the pitch degree of freedom may be controlled by motor 126 located in hip 110, or another location, and used to control rotation of drive wheels 122. A toggle mechanism such as a clutch or gear change device may be used to toggle the motor between operative connection to the drive wheel 122 and the foot 124. In this regard, a singular motor having different torque and speed profiles can be used to control both components of the hybrid mobility assembly 120 (e.g., drive wheels 122 and feet 124), thereby simplifying manufacturing and reducing components and costs.

In one embodiment, this gear or sprocket change can operate similar to a bike gear change with multiple sprockets with the same or different sizes corresponding to the same or different gear reduction ratio. The sprockets may be decoupled such that only the gear or sprocket that is connected to the motor is rotating to control either drive wheel 122 or foot 124 but not both. In another embodiment, when foot 124 is deployed (e.g., in the first position), the foot can have a gear or sprocket transmission that engages with another gear or sprocket transmission that rotates with drive wheel 122 that allows for a different reduction ratio of the foot pitch degree of freedom.

By way of example, drive wheel 122 may be coupled to a planetary gear, as shown in FIG. 5C, such that as the drive wheel rotates a sun gear of a planetary drive also rotates and the planetary carrier and planetary gears become selectively engaged with the sun gear only when it is desired for foot 124 to be deployed (e.g., in the first position) and the foot is coupled to the planetary carrier and rotatable therewith. The sun, the planet, and the ring gear, of the planetary gear can be sized with diameters and/or number of teeth to achieve the desired reduction ratio and torque for the foot pitch relative to the drive wheel. Alternatively, the full planetary gear may always be engaged with the sun gear and the transmission may rotate with the drive wheel 122 but the foot 124 and it’s pitch will only be controlled when a clutch, brake, actuator, manipulator arm, or other motion is controlled to engage or disengage foot 124 relative to the planet carrier or the ring gear, whichever the output. Alternatively, the entire planet carrier or ring gear either of which can be rigidly coupled to the foot can be moved axially relative to the reset of the planetary assembly to engage and disengage the rotation of the ankle (e.g., the foot’s pitch). Different transmission ratios may be employed for controlling rotation of drive wheels 122 and the pitch degree of freedom of feet 124 to facilitate walking.

In constructions in which the feet 124 of robot 100 are pivotable about an axis of leg 106, the feet may biased, via a spring, away from the ground (i.e., pointed upward), and the foot may only be connected to a gear or sprocket that pivots the foot towards the ground when the chain is toggled into operative connection with the foot. In this regard, the feet will remain elevated above the ground when drive wheels 122 are in use. Although feet 124 may be constructed with a roll degree of freedom, in other construction the feet may be relatively narrow rendering the roll degree of freedom less important, and in some instances, unnecessary.

Referring back to FIGS. 1 and 4, robot 100 may include at least one manipulator arm 108 coupled directly to torso 102 or coupled indirectly to the torso via a base. Although robot 100 is illustrated in FIGS. 1 and 4 as including a first manipulator arm located on a first lateral side of torso 102 and a second manipulator arm located on a second side of the torso, it will be appreciated that robot 100 may include a single manipulator arm, or more than two manipulator arms disposed in any orientation about the torso. For example, if robot 100 includes a singular manipulator arm, the manipulator arm 108 may be coupled to the front of torso 102. Each manipulator arm 108 may have at least three degrees of freedom and include a first end coupled to torso 102 at a shoulder 128. Manipulator arm 108 may also include a working end arranged opposite to the first end and configured to removably secure an end effector 129. For example, the working end of the manipulator arm 108 may include a magnet, such as a ring magnet, for magnetically coupling end effector 129 to the manipulator arm. However, end effector 129 may alternatively be secured to manipulator arm 108 via any other non-magnetic quick-change mechanism such as a push/pull or twist-locked mechanical connection or a hybrid mechanism that includes magnets and other mechanical connecting, coupling, constraining or guiding features.

End effector 129 may be pneumatically actuated, for example, end effector 129 may be a gripper such as a suction cup. End effector 129 may alternatively be a 2-finger gripper, clamp having a plurality of pneumatically or electrically actuated fingers for grasping items. Still yet, end effector 129 may include one or more independently actuatable electric or pneumatic fingers that surround a suction cup and that may be used in combination with the suction cup or in isolation of the suction cup. In some embodiments, the fingers themselves may include suction cups for gripping items and/or rollers for manipulating the orientation of grasped items. In other embodiments, end effector 129 may include an array of suction cups provided on a single gripper. A single end effector may, for example, include a plurality of gripping elements arranged in an array to grip large and heavy inventory item at several discrete locations, thereby providing a more stable grasp than a single suction cup, or to grasp multiple items at once.

In further examples, end effector 129 may include other gripping elements such as universal jamming grippers, foam vacuum grippers, pneumatically inflatable fingers, pressure actuated fingers, pneumatically actuated linkage or piston driven grippers with rigid or compliant fingers, any other electrically or pneumatically driven or vacuum driven (positive or negative pressure) gripper elements, and/or electromechanics entirely disposed within the end effector. For example, end effector 129 may be electromechanically actuated with one or more independently actuated degrees of freedom as is the case with an anthropomorphic hand or multi-fingered hand or gripper. The hand may have one or more fingers, with one, two or multiple opposing thumbs. Each finger may have one or more active, coupled and/or passive joints and/or degrees of freedom. Fingers, palm and/or any other outer surface of the robot can have contact sensors, haptic sensors, cameras, or sensors that detect distance without contact (IR, etc.). In one embodiment, the contact sensors may include GelSight sensors which uses a deformable gel with a reflective coating and a camera to capture high resolution images of surface textures, shapes, and forces upon contact with an object, enabling dense detailed tactile sensing. The GelSight sensor, or similar sensor, works by pressing a soft, elastomeric gel layer with a reflective coating against an object, causing the gel to deform and conform to the object's surface texture and shape. A high-resolution camera inside the sensor captures images of the deformed gel, which may then be analyzed using algorithms to extract detailed information about surface features, shape, and force distribution. Actuators for a high degree of freedom hand may be co-located in the hand or gripper but could also be located in the arm of the manipulator with mechanical interface that would transfer the motion of the actuators in the arm to the fingers of the gripper while also enabling end effector 129 to be removable. An example construction may include a magnetic pin arrangement where an array of magnets or electromagnets at the working end of arm manipulator 108 engages with an array of magnets or electromagnets at end effector 129, where each magnet in the array is coupled to an actuator in the arm such that when the actuator moves it translates motion to the magnet which then translates motion to the engaged magnet on the end-effector side. It will be appreciated that the aforementioned description is merely an exemplary embodiment describing transferring motion of many independent actuators from the arm to an end effector 129 within a compact form factor. Other mechanisms such as cables with hooks that can be engaged and disengaged from manipulator arm 108 and end-effector 129 can perform the same function and it will be understood that any mechanism can be used to allow the actuators of the end effector to be housed in the arm while allowing the end-effector to be swapped with the same or different end-effectors using the electromechanical and/or pneumatic interface. End effector 129 may also be formed as a universal gripper that has elements with ergonomic interfaces or robot-ergonomic interfaces to engage an interface of a human designed tool or robot ergonomic tool, or to engage a universal interface adapter. In this regard, end effector 129 need not include a “gripping” element for grasping items. End effector may be, for example, a knife for cutting open boxes, a rotating blade, drill or tool bit, a hammer, a screwdriver or any other tool.

In some instances, the shoulder 128 of manipulator arm 108 is designed to move in an upward and downward direction relative to torso 102. The manipulator arm(s) 108 may be movable along torso 102 via a rack and pinion connection as previously described above with respect the hip 110 and the torso, and therefore, this mechanism is not described again in detail herein. Of course, alternative connections other than racks and pinions, such as chains, belts, cables, linkages, friction drives, etc., may be used to move shoulders 128 relative to torso 102. As shown in FIG. 4, the pinion may be provided on the shoulder, thus directly coupling the shoulder 128 and torso 102.

With continued reference to FIG. 4, the head 104 may be fixed to the torso 102 of robot 100 at a neck, and include a vision device 130 such as a camera (depth and/or RGB), sensor video recorder, Light Detection and Ranging (LIDAR), and the like, to capture pictures, point clouds, video etc. (collectively “an image” or “images”) of the surrounding environment to assist the robot in traversing a terrain and in performing manipulation tasks. Alternatively, as shown in FIG. 1, vision device 130 may be disposed within a vision device housing 132 provided with a pinion 118 that is directly coupled to the torso 102 of robot 100 in a manner that allows the vision device housing to move in an upward and downward direction relative to torso 102. In this example, the manipulator arm(s) 108 may be mounted directly to vision device housing 132 such that shoulder 128 isindirectly coupled to torso 102 and moveable relative thereto. In this regard, the vision device housing 132, and in turn the vision device, may be moved in an upward and downward direction along torso 102 and in conjunction with manipulator arm 108. As a result, vision device 130 will automatically be positioned and/or oriented at an angle that is substantially level to manipulator arm 108. This construction improves data collection and significantly increases manipulation success, especially when the item in which robot 100 is tasked with manipulating is located underneath other objects, such as, on a lower shelf or under a seat.

Robot 100, as shown in FIGS. 1 and 4, may have a plurality of manipulator arms 108. Each manipulator arm may have at least three degrees of freedom. In some examples, manipulator arm 108 may have six or seven degrees of freedom providing increased maneuverability of end effector 129. In instances in which robot 100 includes a plurality of manipulator arms 108, each arm may be coupled to torso 102 at independent shoulders 128, and thus, configured to move upwards and downwards relative to the torso independently of the other arms. In this regard, each of the arms 108 may perform independent tasks. Alternatively, manipulator arms may be coupled to a single base, such as vision device housing 132, and thus be configured to move in conjunction with one another.

Additional vision devices 130 such as the cameras described above, or a camera with a fish-eye lens to provide wide-viewing angles, may be provided on the wrists, palms or end effector of robot 100, to further improve data collection during manipulation tasks. Furthermore, any of the vision devices described herein may be located elsewhere on the body, for example, on, in or along the head, neck, arms, legs, or torso for capturing environmental data. In addition, any of the vision devices described herein may be provided with lights, and/or may be mounted on gimbals or have actuated degrees of freedom to allow the camera to roll, pitch, and yaw for enhanced viewing capabilities and greater viewing coverage and orientations from the camera. Similarly, mirrors may be placed strategically around any cameras on the head, arms, legs, grippers, end-effectors, etc. to provide additional viewing angles and perspectives from a single camera without the additional cost incurred by adding more cameras and/or gimbals.

Robot 100 may include a communication interface to send and receive data between the robot and a remote computer 200 and/or a teleoperator interface 300. The data may include environmental data corresponding to the surrounding environment and information relating to the position of robot 100 so that remote computer 200 or a teleoperator can control movement of the robot. The data may include sensor data from any sensor on the robot including images and videos. The data may also include data obtained from a sensor relating to the item in which the robot is tasked with manipulating (hereinafter “Object or Task Data”) (e.g., location, dimensions, shapes, weights, materials, porosities, surface textures, colors, densities, mass distributions, stiffnesses, fragilities or the like) that assist the remote computer 200 or a teleoperator in distinguishing between different products and performing a manipulation task such as a picking task. For example, Object or Task Data and human demonstrations may be collected from remote or local teleoperators, by puppeteering or by hand-held manual grippers outfitted with sensors and/or cameras. Through such data collection and a policy learning framework, robot 100 may directly learn and improve manipulations skills that can be transferred from “in-the-wild human demonstrations” to deployable robot policies.

In some instances, robot 100 may also have onboard microphones to receive commands or communicate with people around the robot. In this regard, robot 100 may receive and/or be controlled or instructed by natural language commands (voice, text) or alternatively hand gestures including sign language from teleoperators or from nearby (local proximity to the robot) or remotely located people speaking via phone, walkie-talkie or other wireless communication methods and use large-language models (LLMs), generative AI, or other AI models to interpret the natural language commands. Vision language models (VLMs) or vision language action (VLA) models or world models may be used by the robot (processing locally on computers or GPUs on robot 100 or remotely in the cloud) to take commands in natural language or otherwise and use those commands combined with sensor and camera observations to perform actions and complete objectives, tasks or goals.

The head 104, or any other part of the robot 100, may house digital screens to present, share or convey information, status, health, intent, and any other data or media whether explicit or implicit to other robots, systems or people. The screen may present a face which may communicate via language and/or non-verbal cues such as gestures, faces, etc.

Any of the robot’s actuators described herein may be direct drive motors, geared motors (harmonic, planetary, spur, cycloidal, or any other gearing mechanisms, transmission drive (belt, chain, cable, tendon, ball or lead screw, rack and pinion, linkages or any other transmission)) or a combination thereof. It will be appreciated that there are many common mechanical drives, actuators, and transmissions that may all be used. The actuators may be modular and fully packaged to include a motor, gearing, motor drive and control electronics, encoding (magnetic, optical or other to encode rotation of the rotor and/or output of the actuator), encoder magnets (which may be diametrically polarized and coupled to the rotor of the motor), cooling fans, heat sinks, sensors that measure directly or indirectly temperature or heat for thermal management, current sensors, deflection sensors for measuring deflection of housings or compliant mechanisms commonly used for torque sensing or in series-elastic actuators, and a variety of other sensor types.

Robot 100 may further include a pneumatic coupler 134 arranged to engage and transition a valve of a pneumatic fluid line from a closed position to an open position to access and receive pneumatic fluid, such as compressed air, from an external pneumatic source (e.g., a pneumatic source spaced from, or not onboard, robot 100). Pneumatic coupler 134 may be in selective, fluid communication with pneumatic end effector 129. In embodiments in which the pneumatically actuated end effect requires suction, and the external fluid source is a pneumatic compressor providing compressed air, robot 100 may include one or more air ejectors, air aspirators, Venturi pumps or similar devices (hereinafter “Venturi pump”) capable of using the compressed air to produce a vacuum or suction force. Thus, when pneumatic coupler 134 engages the valve and accesses a pneumatic fluid supply, robot 100 may utilize the compressed air to create a suction force having high suction and high flow rate.

As illustrated in FIG. 1, pneumatic coupler 134 may be a flexible hose extending from the body of robot 100, for example, from torso 102. In one example, coupler 134 may be on an extendable and retractable. In this regard, robot 100 may use one or more of its manipulator arms 108 to mate the pneumatic coupler to the valve of the pneumatic fluid line and transition the valve from a closed position to an open position to access and receive pneumatics. Alternatively, pneumatic coupler 134 may a static, or extendable hollow tube, that extends from robot 100, for example, from an underside of torso 102, the foot 124 of robot 100, or from any other location that allows pneumatic coupler 134 to selectively engage and disengage with the valve of the pneumatic supply line without assistance from manipulator arm 108. , In either scenario, pneumatic coupler 134 may be in fluid communication with a pneumatic line that is internally routed or embedded directly into the robot’s structure or frame as one or more channels in any component from the coupler in the torso or legs to the manipulator arm 108 and in fluid communication with end effector 129. The parts of the robot’s structure housing the internal pneumatic fluid lines or channels may be constructed via any advanced manufacturing method such as 3D printing.

In one example, pneumatic coupler 134 may include a tapered mating end and/or a self-alignment or misalignment handling device to assist in engaging the coupler with a valve. The mating end of coupler 134 may also include an O-ring that substantially creates a seal to maintain sufficient suction force.

In some embodiments, robot 100 may carry a small onboard air tank 136 such as a scuba tank. The air tank 136 may be in selective communication with pneumatic coupler 134. In this manner, robot 100 need not access an external pneumatic supply each time the robot desires to utilize its pneumatic end effector 129 or other pneumatically actuated components. Instead, robot 100 may rely on the compressed air stored within air tank 136, which robot 100 may occasionally refill, when necessary, by engaging the pneumatic coupler 134 to a valve to access a pneumatic supply from an external pneumatic source. Air tank 136 may include a motor that pressurizes the compressed air within the tank to maintain the compressed air at a suitable pressure for operating end effector 129.

With continued reference to FIG. 1, robot 100 may optionally include one or more secondary, or rechargeable battery, and a utility coupler 140 configured to selectively engage and disengage with a power source. The utility coupler 140 may be structured as a static prong extending from the main body of the robot such that the robot can wheel or walk the prong into a power outlet. Alternatively, the utility coupler may be coupled to a retractable cord and robot 100 may use its manipulator arm to plug the prong into the power outlet. In some embodiments, pneumatic coupler 134 and utility coupler 140 may be located adjacent to one another (e.g., on a single hose/cord or members). Alternatively, pneumatic coupler 134 and utility coupler may be spaced from one another and provided on separate hoses/cords or members.

In embodiments in which robot 100 does not include a utility coupler, robot 100 may “swap” depleted or nearly depleted batteries for charged batteries. For example, robot 100 may utilize its picking arm 108 to remove one or more of its secondary batteries, or one or more secondary batteries of an adjacent robot, when it is depleted or close thereto, and replace the depleted secondary battery with a charged battery. Alternatively, robot 100 may wheel or walk into a “quick swap” battery charging station. In one non-limiting example, the robot may maneuver its body until a hook is secured to the depleted battery before lowering its torso to pop, or otherwise dislodge, the depleted battery from a battery cavity where it will begin charging. Robot 100 may then maneuver its battery cavity underneath a charged battery and move its torso in an upward direction to insert and lock the battery within the battery cavity. In other examples, robot 100 may include a battery chassis including two battery cavities and be configured to simultaneously swap a depleted battery with a charged battery at a charging station. For example, when a depleted battery is located within a first battery cavity of robot 100 (and the second battery cavity of the robot is empty), the robot may engage with a charging station to simultaneously insert a charged battery into the previously empty second battery cavity and remove the depleted battery from the first battery cavity. Any mechanism may be used for simultaneously inserting and releasing the depleted and charged batteries from the battery cavities including, but not limited to, a series of spring-loaded pins and tracks.

Robot 100 may include an end effector holder 138 designed to carry one or end effectors, which may be autonomously and interchangeably connected to the working end of manipulator arm 108 based on the task that the robot has been requested to perform. End effector holder 138 may be fixed to, or removably coupled to, robot 100. For example, end effector holder 138 may be secured about the torso 102 of robot 100 in the form of a tool belt, a fanny pack, backpack, a holster, a chest or vest pack, a food delivery bag or backpack, an arm band, forearm forklift straps, a shoulder dolly, lifting straps, baskets, dispensers, an apron or any similar body mounted holders and accessories used for holding, lifting, etc.. In other embodiments the end effector holder 138 may be formed as an internal cavity for storing end effectors. Alternatively, end effector holder 138 may be stored on or in a transportable bag, toolbox, shelf, cubby, etc. in a setting in which robot 100 is scheduled to perform a task.

While these accessories are primarily described herein as features for temporarily storing end effectors that are not in use (i.e., not currently coupled to the working end of the manipulator arm), it will be appreciated that similar structures and accessories may be used to hold items generally or during transportation tasks where robot 100 may need to use its manipulator arms 108 or transport many items that cannot all be held by the arms alone. Moreover, while feet 124 are primarily described herein as being lifted relative to a respective leg 106 away from the ground, and lowered relative to a respective leg toward the ground, it is also contemplated that feet 124 may be connected and disconnected from leg 106 such that the feet are securable to the leg when it is desirable for the robot to walk, and configured to be disconnected entirely from the leg when it is desirable for robot 100 to traverse a ground surface using drive wheel 122. Feet 124 may be secured to legs 106 using any magnetic, mechanical, compliant mechanism, or electro-mechanical connection, and stored in any of the above-mentioned end-effector holders 138 or on any of the limbs of robot 100 until use of the feet is desired.

Likewise, robot 100 may include a tray table 142, for example, a tray that is pivotable from a position in which it is flush with torso 102 to a deployed position in which the tray is substantially horizontal to the ground in order to secure and hold items during transport. It will be appreciated that if items are secured or resting on tray table 142, the one or more manipulator arms 108 of robot 100 may be free to perform other tasks. Similarly, robot 100 may include one or more hooks 144 that is fixed, or pivotable, from a position in which it is flush with torso 102 to a deployed position for receiving and securing items such as bags for transport. Similarly, robot may include one or more hook lips, t-slots, or cavities that can be used for modularly mounting accessories such as baskets.

Robot 100 may further include at least one stabilizing wheel 146. As shown in FIG. 1, stabilizing wheel 146 may be located on an underside of torso 102 and may swivel about one or more axes. Stabilizing wheel 146 may be smaller, larger or the same size as drive wheels 122. In this regard, when robot 100 desires further stability, for example, during a manipulation task, lifting task, or while transporting a heavy loads on a flat, even surface, etc. the robot may lower torso 102 until stabilizing wheel 146 engages the ground to further stabilize the robot by providing extra points of contact with the ground. Stabilizing wheel 146 may be passive like a caster wheel or actuated with one or more drive motors to control the wheel and swivel axes. Stabilizing wheels 146 and drive wheels 122 can be normal wheels, omni-wheels, mecanum wheels, ball wheels, treads, or wheel or mobility mechanisms.

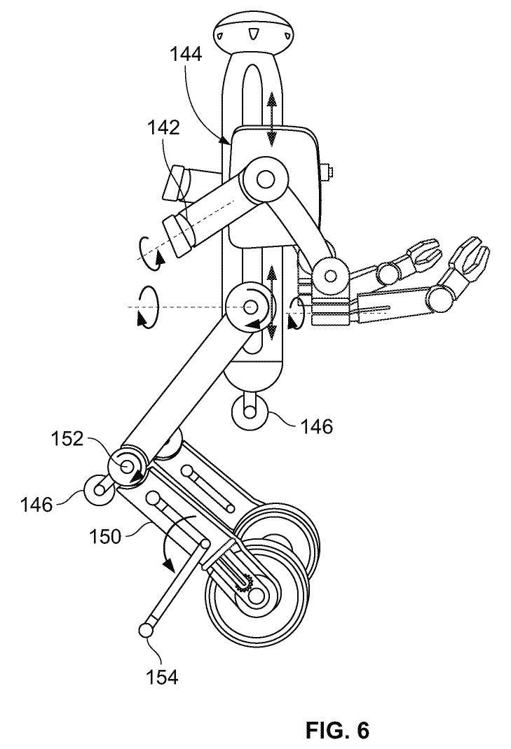

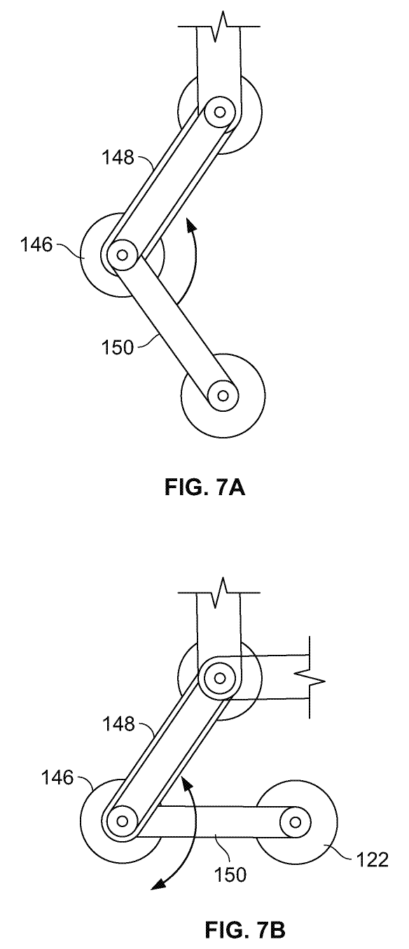

Alternatively, as shown in FIG. 6, legs 106 may include a first link or thigh 148 extending from hip 110 and a second link or shin 150 extending from feet 124 coupled together at a knee 152. In this regard, the shin 150 may be pivotable relative to thigh 148 and about the knee 152. Again, if robot 100 desires static balance and stability, for example, while performing a manipulation task, lifting task, and during transportation of heavy loads, robot 100 may pivot shin 150 relative to thigh 148 until stabilizing wheel 146 mounted on shin 150 or thigh 148 engages the ground (FIG. 7B). On the other hand, if robot 100 desires to quickly traverse across a ground surface or perform a task that requires manipulator arm 108 be elevated well above the ground, robot 100 may lift stabilizing wheel 146 such that robot 100 is actively balanced entirely on mobility assembly 120 (FIG. 7A). The combination of an increased polygon support area provided by the mobility assembly 120 and the stabilizing wheel(s) 146, in combination with the ability of the shoulder 128 to move downward and upwards and relative to hip 110, provides robot 100 with a significantly improved ability to manipulate, lift, reach and transport heavy items from the ground, and is particularly advantageous when such items are located underneath other objects such as on a lower shelf, without sacrificing the robots ability to quickly drive on smooth surfaces or walk across uneven terrain.

Drive wheels 122 and/or stabilizing wheel(s) 146 may also include breaks and/or a locking mechanism designed to prevent the wheels from unintentionally rotating or rolling. Alternatively, or additionally, a pivotable kickstand 154 may be pivotably coupled to each shin 150 to reduce if not eliminate the need for robot 100 to balance solely on its mobility assembly 120 during long stretches in which the robot is performing a task that requires the robot to be solely on its mobility assembly (e.g., when the stabilizing wheels 146 are elevated off the ground). Kickstand 154 may be pivoted or otherwise extended into contact with the ground via a dedicated actuator, use of the manipulator arm 108, prescribed motion of the legs 106 or a combination thereof. Robot 100 may deploy kickstand 154 and use it during walking motions acting as a heel point of contact while the drive wheels 122 (which may have the brake engaged to lock the rotation) can act as a toe, allowing the kickstand and drive wheel to serve as a foot. Kickstand 154 may also have a built-in spring that allows for some heel-toe deflection and foot rolling motions common in walking gaits.

Although the disclosure herein has been described with reference to particular embodiments, it is to be understood that these embodiments are merely illustrative of the principles and applications of the present disclosure . It is therefore to be understood that numerous modifications may be made to the illustrative embodiments and that other arrangements may be devised without departing from the spirit and scope of the present disclosure as defined by the appended claims.

What is claimed:

1. A robot, comprising:
a torso;
a plurality of legs having a first end coupled to the torso at a hip, each of the plurality of legs having at least two degrees of freedom and including a foot and a drive wheel, the foot being moveable relative to the leg between a first position, in which the foot is in contact with the ground and the drive wheel is elevated above the ground, and a second position in which the foot is elevated above the ground and the drive wheel is contact with the ground;
a manipulator arm having a first end coupled to the torso and a working end, the first end of the manipulator arm being moveable in a direction relative to the torso toward and away from the hip; and
an end effector removably securable to the working end of the manipulator arm.

2. The robot of claim 1, further comprising a stabilizing wheel located on a lower end of the torso, wherein the torso is moveable relative to the plurality of legs between a stabilized position in which the stabilizing wheel is in contact with the ground and an elevated position in the stabilizing wheel is elevated above the ground.

3. The robot of claim 1, further comprising a stabilizing wheel located on each of the plurality of legs, wherein each of the plurality of legs is moveable between a stabilized position in which the stabilizing wheel is in contact with the ground and a non-stabilized position in the stabilizing wheel is elevated above the ground.

4. The robot of claim 1, wherein the torso further comprises an upper section and a lower section, and wherein the upper section and the lower section are slidable or pivotable relative to one another.

5. The robot of claim 1, wherein the end effector is pneumatically actuated.

6. The robot of claim 5, further comprising:
an air tank for operating the end effector; and
a pneumatic coupler configured to access compressed air from an external pneumatic source to refill the air tank.

7. The robot of claim 1, further comprising:
an end effector holder arranged to secure the end effector and/or another end effector; and
the another end effector,
wherein the end effector holder and the another end effector are interchangeably coupleable to the working end of the manipulator arm.

8. The robot of claim 1, wherein the foot located on a respective one of the plurality of legs is displaceable relative to the wheel located on the respective one of the plurality of legs between the first position and the second position.

9. The robot of claim 1, wherein the foot located on a respective one of the plurality of legs is pivotable about the respective one of the plurality of legs between the first position and the second position.

10. The robot of claim 1, wherein the torso defines a cavity for storing and transporting items.

11. The robot of claim 1, wherein the torso includes a hook or a tray.

12. The robot of claim 11, wherein the hook or the tray is pivotable between an extended position and retracted position.

13. The robot of claim 11, further comprising a head coupled to the torso, the head including a camera.

14. The robot of claim 11, further comprising a vision system movable in an upward and downward direction relative to the torso.

15. The robot of claim 14, wherein the manipulator arm is coupled to the torso via the vision system such that the manipulator arm and vision system are jointly moveable relative to the torso.

16. The robot of claim 1, wherein each of the plurality of legs includes a thigh pivotably connected to a shin at a joint.

17. The robot of claim 16, further comprising a stability wheel located at the joint of each one of the plurality of legs.

18. The robot of claim 1, wherein the foot is removed from a respective leg when the foot is in the second position.

19. The robot of claim 1, wherein pitch of the foot is adjustable and the pitch of the foot is controllable by a motor using a first transmission ratio, the motor also being arranged to operate the drive wheel using a second transmission ratio.

20. A robot, comprising:
a torso;
a plurality of legs coupled to the torso and having at least two degrees of freedom, each of the plurality of legs including a drive wheel and a kick stand, the kick stand being deployable relative to a respective leg between a first position, in which the kick stand is in contact with the ground when the wheel on the respective leg is stabilized against the ground, and a second position in which the kick stand is elevated above the ground when the wheel on the respective leg is stabilized against the ground;
a manipulator arm having a first end coupled to the torso and a working end, the first end of the manipulator arm being moveable in an upward and downward direction relative the torso; and
an end effector removably securable to the working end of the manipulator arm.
